(19) United States
(12) Patent Application Publication
(10) Pub. No.: US 2008/0169655 A1
(43) Pub. Date: Jul. 17, 2008

(54) Modular Closure Latch Mechanism

(75) Inventor: Fermin Gomez Gonzalez, Guipuzcoa (ES)

Correspondence Address: EGBERT LAW OFFICES, 412 MAIN STREET, 7TH FLOOR, HOUSTON, TX, 77002, US

(73) Assignee: TALLERES DE ESCORIAZA, S.A., E-20305 Irun (Guipuzcoa) (ES)

(21) Appl. No.: 11/914,229

(22) PCT Filed: Jun. 5, 2006
(86) PCT No.: PCT/ES06/00328

§ 371 Date: Nov. 12, 2007

(30) Foreign Application Priority Data
Jun. 28, 2005 (ES) P-200501577

(51) Int. Cl. E05C 19/06; E05B 65/10

(52) U.S. Cl. 292/81

(57) ABSTRACT

Closing latch modular mechanism includes a mechanism casing, a latch with a bevelled surface and a longitudinal surface parallel to the plane of the door, a support, a rotation shaft, an anti-rotation device, a rotatory lever carrying the anti-rotation device, a carriage that is longitudinally displaceable parallel to the plane of the door and a mechanism for actuating the carriage. The latch (2) is installed in the support by the rotation shaft and has a receptacle of semicircular cross-section elongated tangentially at its ends. The receptacle is parallel to the rotation shaft and is situated in its rear surface at a distance from the plane of the door that is suitably greater than the distance of the rotation shaft, and in opposition to the rotation shaft (4).

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

The present invention relates to a closing latch modular mechanism which is designed to be used, in particular, in connection with the anti-panic function of a lock, either a domestic lock or, more especially, a lock installed in an emergency exit door of premises frequented by large numbers of people (dance halls, large shopping areas, shopping malls, office buildings, hospitals, etc.). The anti-panic function of a lock enables the door to be opened from the inside in all circumstances without having to use a key, simply by actuating a handle or pushing or depressing a bar.

This modular mechanism can be used in independently operable locks regardless of their actuating system, i.e. manual, automatic, mechanical or electromechanical. All that is necessary is that this system produce an action capable of activating the mechanism of the invention so as to effect the retraction of the latch.

2. Description of Related Art Including Information Disclosed Under 37 CFR 1.97 and 37 CFR 1.98

Anti-panic opening systems are obligatory in order to facilitate the rapid evacuation of people from areas where large numbers of people congregate, as well as in the domestic sector.

When designing anti-panic systems two mutually contradictory ideas have to be reconciled, namely the safety of people and the security of property.

As regards the safety of people, the actuation of the mechanism must be smooth and require little force. As regards the security of property, the mechanism must be robust in order to resist attempts to force or break the lock, which can compromise the ease and facility of actuation needed to ensure the safety of people. Moreover, it is obvious that the mechanism has to function reliably and be designed and constructed as simply as possible.

At the present time, the trend in this field is to specify standards that are increasingly stringent as regards the safety of people, with the result that existing mechanisms cannot satisfy these standards. Furthermore, on account of their complexity or particular design and construction, the existing mechanisms are difficult to adapt to increasingly stringent standards or can meet these standards only at the cost of a loss of security of property.

Purely by way of illustration, one of these standards specifies that, in the rest state (that is to say, when no pressure is exerted on the door panel equipped with an anti-panic lock), this anti-panic lock can be opened by applying a maximum force of 80 N. The standard also specifies that the same lock can be opened by a force of 220 N when a force of 1000 N is exerted on the door, which is equivalent to the force exerted by four people who would be squashed against the door on account of the almost inevitable stampede caused by panic in emergency escape situations, for example when attempting to escape from a fire inside a locked building. The purpose of this standard is to prevent the numerous fatalities which occur in such stampedes not on account of the direct action of the fire or of the accompanying danger, but by the fact that the bodies of people who are in front are increasingly crushed by people from behind, due to the fact that before the door is opened it is subjected to a pressure which already prevents it being opened subsequently. The pressure is caused by people who, in trying to escape, are crushed against the door before they have been able to actuate the anti-panic bar that would open the door and thereby allow a mass exodus of the fleeing people. However, as has already been said hereinbefore, the difficulty is to satisfy these standards, which are aimed at improving the safety of people while at the same time ensuring an adequate security of property.

The reason why the anti-panic mechanism is not activated when the door is subjected to a foreseeable pressure in cases of human stampede is due to the fact that, in the various designs of devices currently employed for this purpose, the operation to retract the latch is effected by friction between a surface of the latch and a surface of its lock. If an excessive pressure is exerted on such surfaces before the retraction is initiated, then the mechanism is inactivated, which blocks the operation.

In this connection, a normal type of mechanism consists of a catch of conventional shape that has a beveled front surface that rests against the lock when the door is in contact with the frame, as well as a longitudinal opposite surface that remains in contact with an internal wall of the lock, thereby preventing the door from being opened while the catch is not retracted. In this type of mechanism, the retraction is effected by a linear frictional movement on the lock, whereby as soon as a pressure that is not too large is exerted on the locked door, although the opening of the anti-panic device is then actuated, the force of the latter will still not be able to retract the latch.

Other types of mechanisms employ a latch which, since it involves a rotational movement to open or lock the door, means that the keeper has a curved convex or curved concave surface. In these mechanisms, the release of the latch is effected by combining a rotational displacement with a linear displacement. In these types of mechanisms, the rotation of the latch takes place with respect to a shaft which is attached to the front of the latch and in the most remote part of the keeper in relation to the rotational movement to open the door, starting from its locked position on the frame. In some cases, the rotation shaft can be displaced along a longitudinal path by connecting it to displaceable connecting rod-type means that are subjected to a force that is exerted by means of an electromagnet or a permanent magnet.

In order to achieve the operative rotation of the latch, the longitudinal path is combined with another curved path which is traversed by a second shaft of the latch which is at the end of the curved convex surface which is opposite the most projecting part of the emergent position of the latch. In other cases, both shafts of the latch can be displaced along both curved parts. In these types of mechanisms, the problems of blocking by inactivation, preventing the retraction of the latch under an excessive pressure applied to the door, occur in a similar way. Moreover, the interlocking forces that can be exerted by electromagnetic means are not sufficiently reliable so as to ensure that the correct positioning has been achieved for defining the locking state of the mechanism. Apart from this, these known mechanisms comprise kinematic linkages that involve a large number of interconnected movable elements, as a result of which it is difficult to manufacture them with a sufficient degree of robustness that satisfies the aforementioned standards. Moreover, they are inclined to malfunction and are also subject to wear and tear.

### BRIEF SUMMARY OF THE INVENTION

In view of this state of affairs, the object of the present invention is a closing latch modular mechanism which comprises a mechanism casing, a latch head or latch per se, which has a conventional configuration with a beveled surface and a longitudinal surface parallel to the plane of the door, a support for the latch, a rotation shaft of the latch, an anti-rotation device of the latch, a rotatory lever carrying the said anti-rotation device, a carriage that is displaceable longitudinally parallel to the plane of the door, and means for actuating the carriage. The latch is installed in the support by means of the rotation shaft, having a receptacle of a semicircular cross-section elongated tangentially at its ends, which is parallel to this rotation shaft and is situated in its rear surface at a distance from the plane of the door which is suitably larger than that of the rotation shaft.

In opposition to the rotation shaft, this latch has a projection that in front abuts against a wall of the support, the rotation shaft being situated adjacent to the front part of this casing and closer to the plane of the door than is the longitudinal surface of the latch. The support and rotation shaft are longitudinally displaceable at the same time with respect to the casing of the mechanism by means of both first and second tracks. The anti-rotation device has a circular cross-section adapted as required to that of the receptacle and is installed via a said rotatory lever, which at its end furthest from the door has a rotational linkage with respect to the support. At its other end, on the front side, the remaining rotatory lever forms a concavity which, in the emergent position of the latch, is opposite a crosspiece of a carriage that comprises means that operate in conjunction with the said actuating means for said carriage.

The modular mechanism also comprises a first helical spring and first, second and third torsion springs. The first helical spring is installed between the support and the casing of the mechanism so that it has a state of maximum relative relaxation in conjunction with the most forward positions of the said latch and support. The first torsion spring is installed on the rotation shaft between the latch and its support so that it has states of maximum relaxation and tension coinciding with respective positions of extension or rest, and release or rotation, of the latch. The second torsion spring is installed between the support and the anti-rotation device so that it has states of maximum relaxation and tension coinciding with respective positions of the anti-rotation device inside and outside the receptacle of the latch. The third torsion spring is installed between the carriage and the casing of the mechanism so that it has states of maximum relaxation and tension coinciding with respective front and rear positions of this carriage.

In order to explain the mode of operation of the mechanism, starting from the rest position, in which the latch is inside its keeper, the catch support and the carriage are in the front position, the anti-rotation device is inside the rear receptacle of the latch, and the first helical spring and the first, second and third torsion springs are all in the relaxed state. On moving the carriage to the rear by any anti-panic actuating means known per se (mechanical or electromechanical), the crosspiece thereof presses on the concavity of the rotatory lever and causes the latter to rotate in its rotational joint, thereby compressing the second torsion spring and displacing the anti-rotation device from its rear receptacle in the latch. Then, when the door is pressed in the opening direction, the simple action of the keeper on the latch causes rotation about its axis, releasing it into the cavity of the casing of the mechanism, which takes place with the compression of the first torsion spring, which in turn restores the starting position as soon as the door becomes separated from its frame.

When the door is returned to its position flush with the frame, since the abutment of the beveled surface of the latch on the frame is unable thereby to rotate the latch (since the top of the projection of the latch is against the wall of the support), it causes the longitudinal retraction of the latch per se, from its support and from the carriage, thereby tensioning the first helical spring and the third torsion spring. Upon reaching the cavity of the keeper the latch returns and leaves its rest position as a result of the elastic recovery of the said first helical spring and third torsion spring.

This proposed mechanism is sensitive, robust and reliable. It contains a small number of parts connected to one another in a simple manner, without the need for complex kinematic linkages involving a large number of movements between their component parts. To effect opening, the latch is released simply by rotation about only one shaft, without involvement of the type of friction that is found in those solutions in which the latch is retracted longitudinally, sliding on the internal wall of the keeper, where blockages occur that prevent the door opening when subjected to the pressure of people who have fallen against the door on being squashed by others attempting to flee from imminent danger. This type of release satisfies the most stringent standard mentioned hereinbefore as regards the safety of people, while providing a high degree of security for property thanks to a high basic robustness. Its design allows the anti-rotation device to be as solid and bulky as necessary. In addition, there is a wide margin for varying the dimensions of the remote rotatory lever to the advantage of the anti-rotation device with respect to the articulation of this lever and the concavity of the latter, on which the crosspiece of the carriage acts. The couplings between the parts are mechanical and are more reliable than those encountered in magnetic elements, which can be actuated unintentionally when the parts that are to be coupled are not yet in their proper positions, besides which their actuation depends on there being no breakdown in the power supply.

On the other hand, the proposed mechanism is compatible with any type of lock and actuating technology provided that this is arranged so as to effect the traction of the carriage in the sense of displacing the anti-rotation device from its receptacle in the latch. In this connection, an envisaged modification of the invention consists in that the actuating means for the carriage comprises a puller (traction means) that is coupled to the carriage by means of a third track so that its working path and its longitudinal position are in conjunction with the travel length and the front and rear operating positions of the carriage.

This implementation by means of a puller is suitable for application in an emergency door locking device operated by means of an anti-panic bar which, when pushed, causes the displacement of the puller, which then pulls the carriage so as to release the anti-rotation device of the latch. In accordance with a preferred implementation in this connection, the envisaged mechanism has a reversible design and construction for right-hand and left-hand doors, symmetrical with respect to the longitudinal mid plane of the latch, comprising a handle, a rotating plate, second and third rockers, first and second slide rims, and first and second locks actuated by a key. The rotating plate is rotatably coupled to the handle and is longitudinally convex towards the floor of the casing. Two diametrically opposite leaves are perpendicular to the convexity and are capable of adopting two disengaged and engaged handle operating positions that are respectively closer to or further from the floor of the casing. The second and third rockers have their rotation shaft fixed to the casing. Both have pivots rotatably linked with respect to the carriage and which rotatably engage with the leaves of the rotating plate when this is situated in its position remote from the floor of the casing or engaged handle. The pivots are capable of rotating between two positions that are congruent with those of the anti-rotation device inside and outside the rear receptacle of the latch. The first and second rims are supported on the floor of the casing, having an edge of a wedge-shaped cross-section at an appropriate distance from the convexity, and a notch that operates in conjunction with the eccentric of the first and second locks, thereby generating an operative travel of these rims between active and inactive positions that are congruent with the disengaged and engaged handle positions.

Starting from a position in which the mechanism is arranged so as to function as described hereinbefore, the handle is in the disengaged state and its actuation does not have the effect of acting on the latch. In other words, in this situation both rims are in their inactive position determined by the action of the eccentric of the first and second locks on the notch of these rims. In order to engage the handle, the eccentric of the appropriate one of these locks is actuated, following which the corresponding rim is introduced underneath the rotating plate (by pushing the wedged edge of the first against the convexity of the latter), thereby separating it from the floor of the casing so that, on rotation, one of its leaves presses on the pivot of one of the rims (the corresponding one), effecting the retraction of the carriage and, thereby, causing the anti-rotation device to leave the receptacle of the latch. This operation allows access from the outside by authorized personnel.

In the case where other locking points exist that are controlled from the main lock, as opposed to the pivots, the second and third rockers have a pin that slidably engages in a groove of both first and second straightedge plates. These plates are slidably guided in the direction perpendicular to the travel of the latch and are capable of acting respectively on top and bottom complementary locking points situated in the same vertical frame of the central locking means and/or in the doorsill and doorhead frames.

### BRIEF DESCRIPTION OF THE SEVERAL VIEWS OF THE DRAWINGS

In order to obtain a better understanding of the nature of the invention, an example of an industrial realization of the invention is described hereinafter purely by way of illustration and in a non-limiting manner, with the aid of the accompanying drawings.

FIG. 1 is a diagrammatic perspective view of a door (47) provided with a main or central attached lock (48) that incorporates the mechanism of the invention, and also comprises an anti-panic push bar (49) and top (51) and bottom (52) complementary locking points, the whole arrangement being suitable for general application as will be explained hereinafter. This Figure incorporates an enlarged portion which shows an orthogonal projection corresponding to the section indicated in the circled detail in the perspective view, but in the case where there is no handle (30).

FIGS. 2 to 4 are schematic views illustrating the operation sequence involved in opening the door (47), starting from the position shown in FIG. 1.

FIGS. 5 and 6 are schematic views illustrating the operation sequence involved in locking the door (47), starting from the position shown in FIG. 4.

FIGS. 7 and 8 are schematic views illustrating the actuation of the first rocker (24) when the door (47) is in the frame and separated from the latter.

FIGS. 9 and 10 are respective enlarged perspective views of the details IX and X encircled in FIGS. 7 and 8.

FIG. 11 is a sectional view equivalent to the enlarged detail of FIG. 1, but for the case where a handle (30) exists.

FIG. 12 is another sectional view of an upper horizontal projection corresponding to the mechanism of FIG. 11 and for the particular case in which this is applied to an anti-panic push bar (49).

FIG. 13 is a perspective view of the lock of FIG. 12. In order to assist the understanding, the latch (2) and the carriage (7) have been omitted. The position of the mechanism is that of the extended latch (2) and disengaged handle (30).

FIG. 14 is a perspective view similar to FIG. 13, and incorporates the carriage (7) and corresponds to the engaged and rotatably actuated handle (30).

FIG. 15 is a sectional view of an upper horizontal projection of the mechanism according to FIG. 13.

FIG. 16 is another sectional view similar to FIG. 15, now showing the handle (30) engaged but not rotatably actuated.

FIG. 17 is a sectional view of an upper horizontal projection of the mechanism according to FIG. 14.

FIG. 18 is an enlarged sectional view of the section XVIII-XVIII shown in FIG. 15.

FIG. 19 is a sectional view similar to FIG. 18, consisting of an enlargement of the section XIX-XIX shown in FIG. 16.

### DETAILED DESCRIPTION OF THE INVENTION

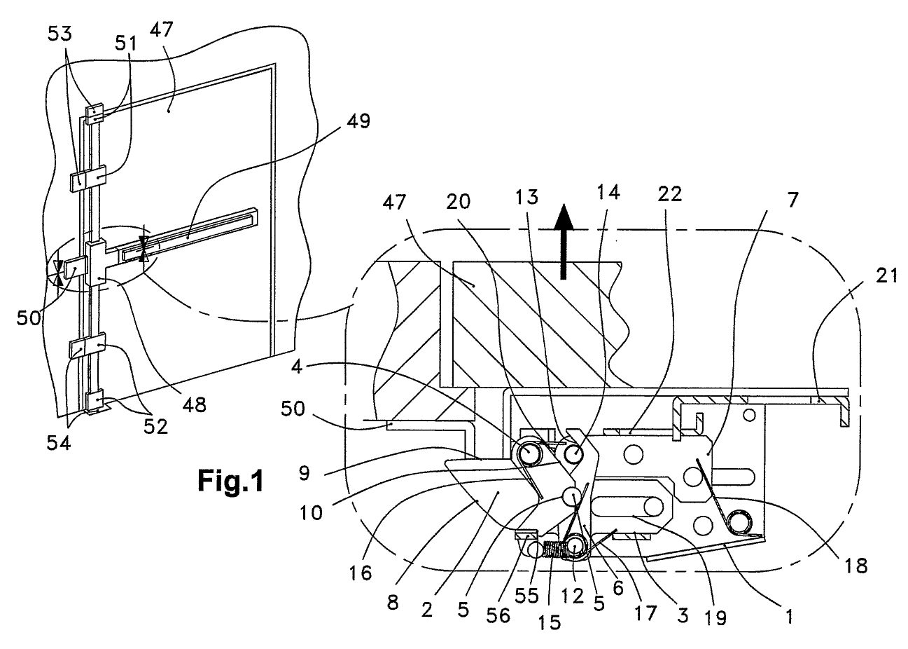

With reference to the drawings and aforementioned reference numerals, a preferred embodiment of the object of the invention is illustrated in the accompanying drawings, and relates to a modular mechanism (see FIG. 1). The modular mechanism comprises a mechanism casing (1), a latch head or latch (2) per se, which has a conventional shape with a beveled surface (8) and a longitudinal surface (9) parallel to the plane of the door (47), a support (3) of the latch (2), a rotation shaft (4) of the latch (2), an anti-rotation device (5) of the latch (2), a rotatory lever (6) carrying the anti-rotation device (5), a carriage (7) that is displaceable longitudinally parallel to the plane of the door (47), and means for actuating the carriage (7). The latch (2) is installed in the support (3) by means of the rotation shaft (4), has a receptacle (11) of semi-circular cross-section elongated tangentially at its ends, which is parallel to the rotation shaft (4) and is situated on its rear surface (10) at a distance from the plane of the door (47) which is suitably larger than that of the rotation shaft (4).

In opposition to the rotation shaft (4), this latch (2) has a projection (53) that in front abuts against a wall (54) of the support (3), the rotation shaft (4) being situated adjacent to the front part of this casing (1) and closer to the plane of the door (47) than is the longitudinal surface (9) of the latch (2). The support (3) and rotation shaft (4) is longitudinally displaceable at the same time with respect to the casing (1) of the mechanism by means of both first (19) and second (20) tracks. The anti-rotation device (5) is of circular cross-section adapted as required to that of the receptacle (11) and is installed by means of the rotatory lever (6) which at its end furthest from the door (47) has a rotational linkage (12) with respect to the support (3). At its other end, on the front side, this rotatory lever (6) forms a concavity (13) which, in the emergent position of the latch (2), remains against a crosspiece (14) of the said carriage (7) which comprises means that operate in conjunction with the actuating means of the carriage (7).

The modular mechanism also comprises a first helical spring (15) and first (16), second (17) and third (18) torsion springs, such that the first helical spring (15) is installed between the support (3) and the casing (1) of the mechanism so that it has a state of maximum relative relaxation in conjunction with the most forward positions of the latch (2) and support (3). The first torsion spring (16) is installed on the rotation shaft (4) between the latch (2) and its support (3) so that it has states of maximum relaxation and tension coinciding with respective positions of extension or rest, and release or rotation, of the latch (2). The second torsion spring (17) is installed between the support (3) and the anti-rotation device (5) so that it has states of maximum relaxation and tension coinciding with respective positions of the anti-rotation device (5) inside and outside the receptacle (11) of the latch (2). The third torsion spring (18) is installed between the carriage (7) and the casing (1) of the mechanism so that it has states of maximum relaxation and tension coinciding with respective front and rear positions of this carriage (7). According to a preferred embodiment, the receptacle (11) for the anti-rotation device (5) is related to the longitudinal mid plane of the latch (2). Similarly, in accordance with a preferred embodiment, the rotatory linkage (12) of the rotatory lever (6) is at a greater distance from the door (47) than is the side of the latch (2) opposite the longitudinal surface (9) thereof.

The perspective view of FIG. 1 shows diagrammatically a door (47) with a generic locking system in which, apart from the central lock (48), there is a handle (30), an anti-panic push bar (49) and complementary top (51) and bottom (52) locking devices arranged both in the plane itself of the central lock (48) as well as in the doorsill and doorhead frames. In accordance with what has been described hereinbefore in connection with the envisaged mechanism, as well as in accordance with the following description, it is clear that the mechanism may be employed universally, namely for locking systems with a single conventional central lock (48), with an internal anti-panic handle (30), for cases where there are also top (51) and bottom (52) locking devices, for cases where the actuation is by means of a push-type (or lever-type) anti-panic bar (49), or for cases where the actuation is by electromechanical means. The only requirement is that the actuating means exert the necessary traction on the carriage (7) and that engagement means are provided for the handle (30) and also means known per se are provided so that the top (51) and bottom (52) locking devices are actuated via transmission of the actuation of the central lock (48).

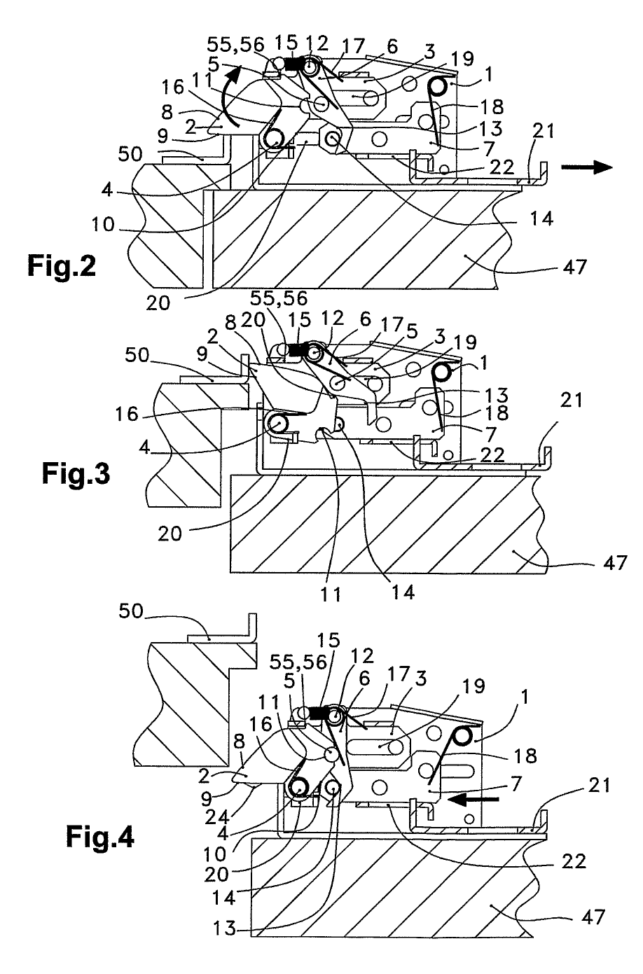

FIGS. 2 to 4 illustrate the mode of operation starting from the rest position shown in FIG. 1. Insofar as the traction is exerted on the carriage (7) (FIG. 2), the crosspiece (16) causes the rotatory lever (6) to tilt, thereby displacing the anti-rotation device (5) from the rear receptacle (11) of the latch (2), this being arranged so as to rotate on its shaft (4) (FIG. 3) and thereby slip into the casing (1) under the intrinsic pressure that is exerted by the keeper (50) when the door (47) is caused to open, separating the door from its frame. In this operation, the first (16) and second (17) torsion springs are compressed, which after the door has been opened recover their initial state and bring the mechanism (FIG. 3) into the rest position shown in FIG. 1.

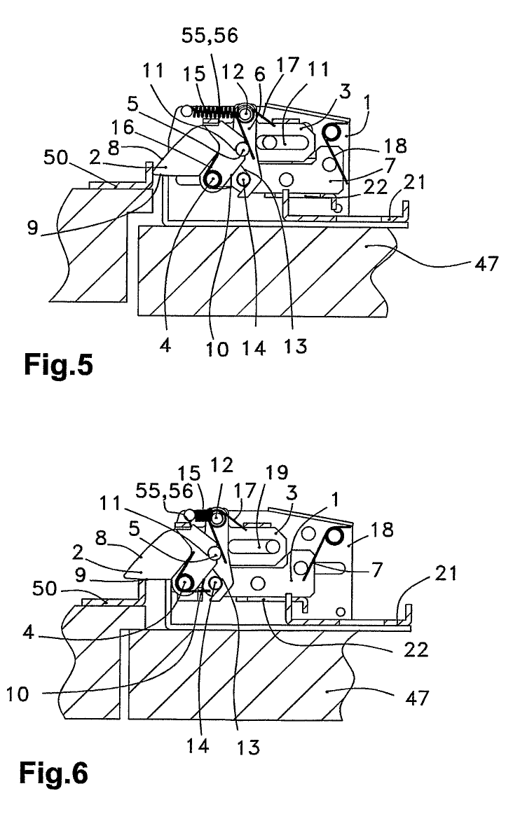

Starting from this rest position, the operation of locking the door (47) is illustrated by means of FIGS. 5 and 6. To start with, the beveled surface (8) of the latch (2) rests against the frame and, since this latch (2) is not able to rotate towards the left-hand side of the drawing since the top of its projection (55) rests against the wall (56) of the support (3), the support (3) and the carriage (7) are jointly retracted under the corresponding tension of the first helical spring (15) and of the third torsion spring (18) (FIG. 5), which (FIG. 6) recover elastically, forcing the release of the latch (2) on reaching its keeper (50).

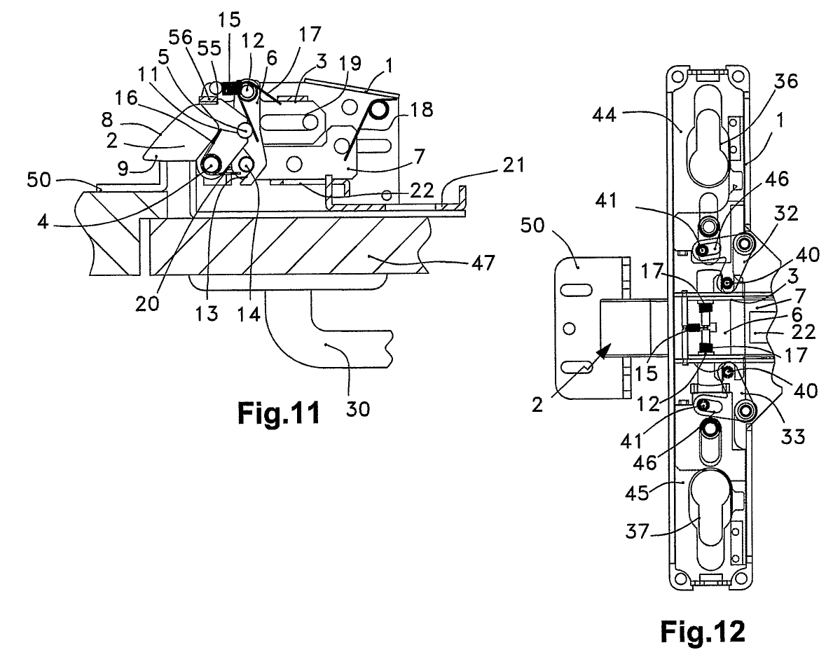

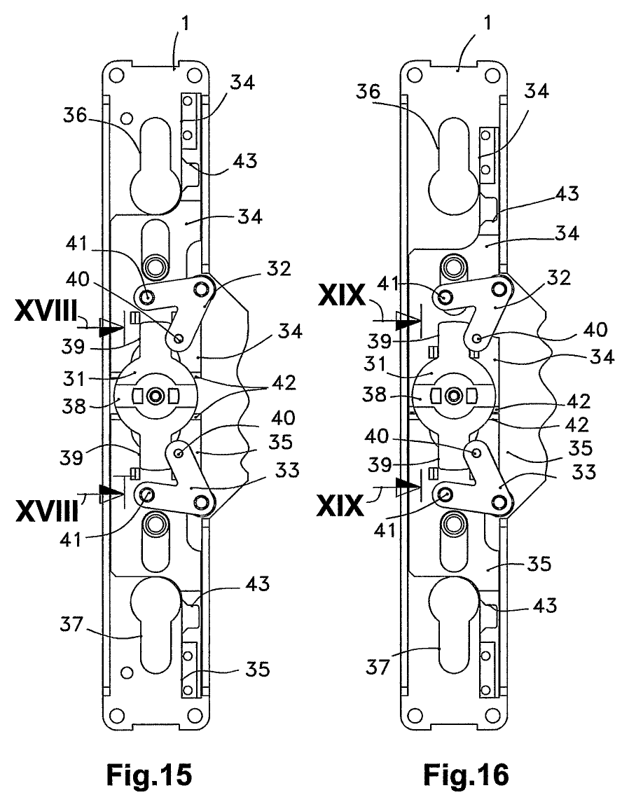

FIGS. 11 to 19 illustrate the application of the mechanism of the invention to the case where a handle (30) is incorporated, comprising an engagement mechanism actuated by means of a cylindrical combination key, as well as an anti-panic push bar (49) and top (51) and bottom (52) locking devices actuated by means of first (44) and second (45) straightedge plates.

To this end, the actuating means of the carriage (7) comprise a puller (21) which is coupled to the carriage (7) by means of a third track (22), such that its working path and its longitudinal position coincide with the travel length and the front and rear operating positions of the said carriage (7). Furthermore, the mechanism according to the invention has a reversible design and construction for left-hand and right-hand doors (47), being symmetrical with respect to the longitudinal mid plane of the latch (2), and comprising a handle (30), a rotating plate (31), second (32) and third (33) rockers, first (34) and second (35) slide rims, and first (36) and second (37) locks actuated by a key. The rotating plate (31) is rotatably coupled to the handle (30), has a longitudinal convexity (38) towards the floor of the casing (1), has two diametrically opposite leaves (39) that are perpendicular to the said convexity (38) and are capable of adopting two, namely a disengaged and engaged, operating positions of the handle (30), which are respectively closer to or more remote from the floor of the casing (1).

The second (32) and third (33) rockers have their rotation shaft fixed to the casing (1). Both have pivots (40) rotatably linked with respect to the carriage (7), which engage rotatably with the leaves (39) of the rotating plate (31) when the latter is situated in its remote position relative to the floor of the casing (1) or engaged handle (30), and which are capable of rotating between two positions congruent with those of the said anti-rotation device (5) inside and outside the rear receptacle (11) of the catch (2). The first (34) and second (35) rims rest on the floor of the housing (1), have an edge (42) of wedge-shaped cross-section spaced an appropriate distance from the convexity (38), and have a notch (43) that operates in conjunction with the eccentric of the first (36) and second (37) locks, thereby producing an operational travel of these rims (34, 35) between inactive and active positions that are congruent with respectively the disengaged and engaged positions of the handle (30).

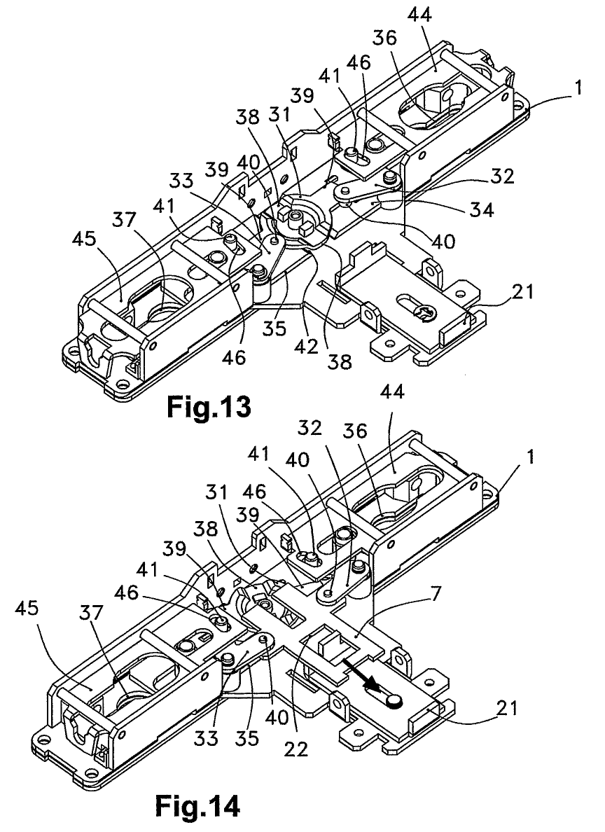

Moreover, an implementation is envisaged according to which, in contrast to the pivots (40), the second (32) and third (33) rockers have a pin (41) that slidably engages in a groove (46) of both first (44) and second (45) straightedge plates, which are slidably guided in the direction perpendicular to the travel of the latch (2) and which are capable of actuating respective top (51) and bottom (52) complementary locking points situated in the same vertical frame of the central lock and/or in the doorsill and doorhead frames. In FIG. 13, the handle (30) is disengaged or in its position closest to the floor of the casing (1). The rockers (32, 33) are in the non-tilting or rest position, the rims (34, 35) are in their position remote from the rotational plate (31), and the straightedge plates (44, 45) are in their extended or most remote position from this plate (31).

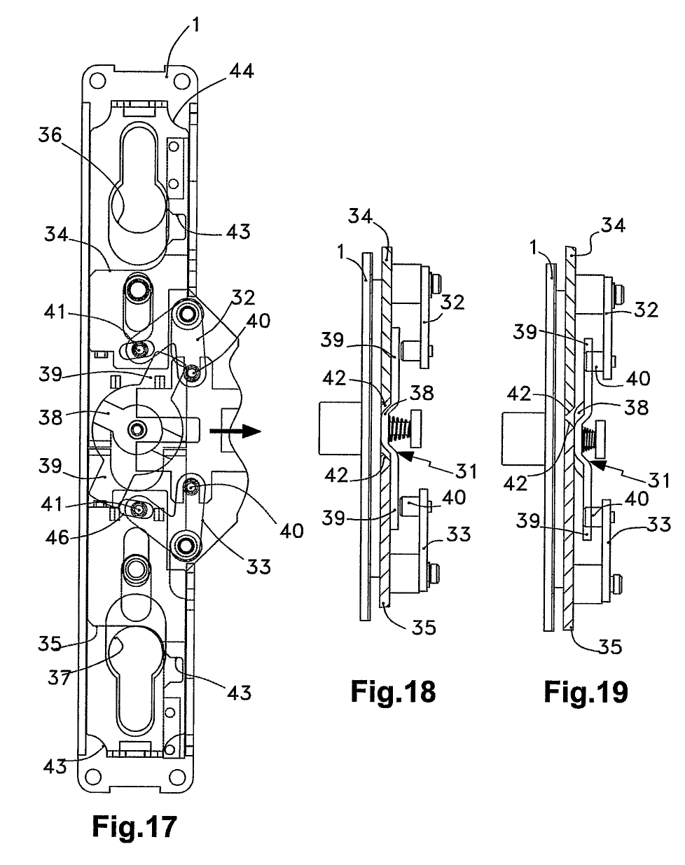

The position of the rims (34, 35) is produced by the action of the eccentric of the corresponding lock (36, 37) in the notch (43). When this eccentric is actuated (the upper one in FIGS. 16 and 19), the first rim (34) drops and presses with its edge (42) against the convexity of the plate (31), which reaches its most distant position from the floor of the casing (1). One of its leaves (39), on rotation of the handle (30), presses against the pivot (40) of the corresponding rocker (32, 33) and (FIGS. 14 and 17) effect the retraction of the carriage (7), which initiates the tilting of the other rocker (32, 33). As a result, the anti-rotation device (5) is displaced from the receptacle (11), thereby allowing the catch (2) to be released, at the same time as the pins (41) of these rockers (32, 33) engage in the groove (46) of the straightedge plates (44, 45), thereby raising these to the withdrawn position closest to the plate (31).

Another object of the present invention consists in that a first rocker (24), which is rotatably installed on its own rotation shaft (4) of the latch (2), is present in a cavity (23) of the latch (2) open along its longitudinal surface (9). In relation to the projecting position of rest of the latch (2), this first rocker (24) has first (25) and second (26) arms that are located respectively outside and inside the casing (1) of the mechanism. Between this first arm (25) and the bottom of the cavity (23), a second helical spring (27) is interposed that has respective compressed and relaxed states in which the first arm (25) remains inside or outside the said cavity (23). Corresponding to these positions of the first arm (25), a front part (28) of the second arm (26) oriented transversely to the door (47) remains longitudinally opposite, and adjacent or offset with respect to a projection (29) of the casing (1) of the mechanism.

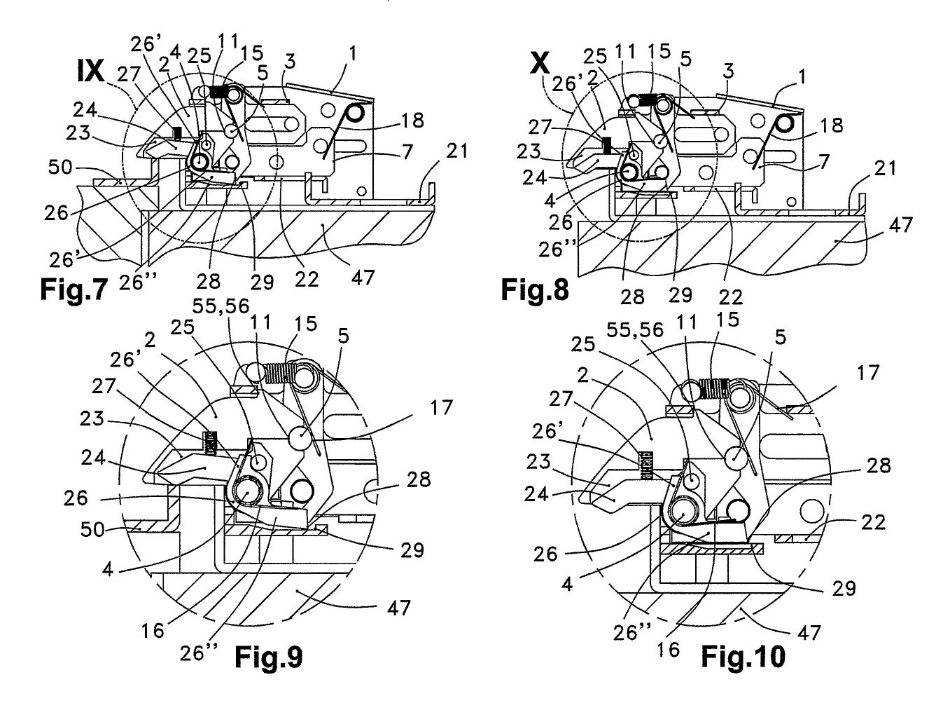

This device and its function are illustrated in FIGS. 7 to 10. The device is intended to prevent the catch (2) being able to be released from outside by the conventional method of inserting a credit card or the like between the small gap that always remains between the locked door (47) and its lock frame. If this maneuver is attempted (FIGS. 7 and 9), the catch (2) cannot move back since the first rocker (24) is tilted against the second helical spring (27). The front part (28) of the second arm (26) remains bearing against the projection (29) belonging to the casing (1) which is fixed to the door (47). When the door (47) moves from its frame, the elastic recovery of the second helical spring (27) (FIGS. 8 and 10) lifts the first rocker (24) to its rest position, corresponding to that shown in FIG. 4, in which the latch (2) is available for the manoeuvre of locking the door (47) to its frame.

1. Closing latch modular mechanism, comprising:
a mechanism casing;
a latch with a conventional configuration, having a beveled surface and a longitudinal surface parallel to a plane, said latch having a support, a rotation shaft, an anti-rotation device, and a rotatory lever carrying said anti-rotation device;
a carriage being displaceable longitudinally parallel to said plane; and
means for actuating said carriage,
wherein said latch is installed in said support by said rotation shaft, said latch further comprising a receptacle of semicircular cross-section elongated tangentially at ends thereof, said receptacle being parallel to said rotation shaft and situated in a rear surface thereof at a distance from said plane, being suitably larger than said rotation shaft,
wherein said latch has a projection having a front abutted against a wall of said support, said rotation shaft being situated adjacent to a front part of said mechanism casing and closer to said plane than said longitudinal surface of said latch, said support and rotation shaft being longitudinally displaceable at the same time with respect to the casing and second tracks,
wherein said anti-rotation device has a circular cross-section adapted to said receptacle, being installed by said rotatory lever, and having a rotational linkage an at end furthest from a door with respect to said support, said rotational linkage forming a concavity at another end, on a front side, thereof, said concavity, in an emergent position of said latch, being against a crosspiece of said carriage, said crosspiece comprising a means to operate in conjunction with said means actuating said carriage, said modular mechanism further comprising:
a first helical spring; and
first, second and third torsion springs, said first helical spring being installed between said support and the casing, said first helical spring being in a state of maximum relative relaxation in conjunction with most forward positions of said latch and support, said first torsion spring being installed on said rotation shaft between said latch and its said support, said first torsion spring having states of maximum relaxation and tension coinciding with respective positions of extension or rest, and release or rotation, of said latch, said second torsion spring being installed between said support and said anti-rotation device, said second torsion spring having states of maximum relaxation and tension coinciding with respective positions of said anti-rotation device inside and outside said receptacle of said latch, said third torsion spring being installed between said carriage and the casing, said third torsion spring having states of maximum relaxation and tension coinciding with respective front and rear positions of said carriage.

2. Closing latch modular mechanism according to claim 1, wherein said receptacle for said anti-rotation device is in a longitudinal mid plane of said latch.

3. Closing latch modular mechanism according to claim 1, wherein said rotational linkage of the rotatory lever is at a greater distance from the door than a side of said latch opposite said longitudinal surface thereof.

4. Closing latch modular mechanism according to claim 1, wherein said means actuating the carriage comprises:
a puller coupled to the said carriage by a third track, said puller having a working path and longitudinal position in conjunction with travel length and front and rear operating positions of said carriage.

5. Closing latch modular mechanism according to claim 1, further comprising:
a first rocker rotatably installed on said rotation shaft of said latch, said first rocker being present in a cavity of said latch and being open along a longitudinal surface thereof, in relation to a projecting rest position of said latch, said first rocker having first and second arms situated respectively outside and inside the casing; and
a second helical spring interposed between the first arm and a floor of said cavity, said second helical spring having respectively compressed and relaxed states, the first arm remaining inside or outside said cavity, and, wherein, corresponding to positions of the first arm, a front part of the second arm is oriented transversely to the door, being longitudinally facing and adjacent or offset with respect to a projection of the casing.

6. Closing latch modular mechanism according to claim 1, being reversible and constructed for left-hand and right-hand doors, symmetrical with respect to the longitudinal mid plane of the latch, further comprising:
a handled,
a rotational plate;
second and third rockers;
first and second slide rims; and
first and second locks actuated by a key,
wherein the said rotational plate is rotatably coupled to said handle (30), having a longitudinal convexity towards a floor of the casing and two diametrically opposite leaves perpendicular to the convexity, adopting two disengaged and engaged operating positions of said handle, being respectively closer to or further away from the floor of said casing, said second and third rockers having rotation shafts fixed to the casing, and pivots rotatably linked with respect to said carriage, rotatably engaging said leaves of the rotational plate when situated in a position remote from the floor of the casing or engaged plate, said pivots rotating between two positions congruent with positions of said anti-rotation device inside and outside the rear receptacle, the first and second being joined to the floor of the casing and having an edge of wedge-shaped cross-section situated at an appropriate distance opposite the convexity (38) and a notch being operable in conjunction with an eccentric of the first and second locks, thereby forming an operating path of rims between inactive and active positions congruent with disengaged and engaged positions of the handle.

7. Closing latch modular mechanism according to claim 6, wherein, in contrast to the pivots, the second and third rockers comprise a pin slidably engaging in a groove of both first and second straightedge plates slidably guided in a direction perpendicular to a path of said latch catch and actuating respective top and bottom complementary locking points situated in a same vertical plane of said central locking device, in a doorsill or in a doorhead frames.
